(19) United States
(12) Patent Application Publication
(10) Pub. No.: US 2025/0062418 A1
(43) Pub. Date: Feb. 20, 2025

(54) SECONDARY BATTERY AND METHOD OF MANUFACTURING THE SAME

(71) Applicant: MURATA MANUFACTURING CO., LTD., Kyoto (JP)

(72) Inventors: Takuya HORIE, Kyoto (JP); Hikaru KUJIRADA, Kyoto (JP)

(21) Appl. No.: 18/934,553

(22) Filed: Nov. 1, 2024

Related U.S. Application Data
(63) Continuation of application No. PCT/JP2023/026088, filed on Jul. 14, 2023.

(30) Foreign Application Priority Data
Aug. 26, 2022 (JP) 2022-135347

(51) Int. Cl. H01M 10/0585; H01M 10/0525; H01M 50/46; H01M 50/463

(52) U.S. Cl. CPC H01M 10/0585; H01M 10/0525; H01M 50/46; H01M 50/463

(57) ABSTRACT

A secondary battery is provided and includes a battery element including a positive electrode 2 and a negative electrode that are stacked with a separator 1 interposed therebetween; and an exterior body housing the battery element, and the separator 1 has two or more first recesses 10a and one or more second recesses 10b disposed between two first recesses adjacent to each other among the two or more first recesses 10a in one periphery facing region (including outer regions x and y) facing a periphery of the positive electrode.

### CROSS REFERENCE TO RELATED APPLICATIONS

The present application is a continuation of International patent application no. PCT/JP2023/026088, filed on Jul. 14, 2023, which claims priority to Japanese patent application no. 2022-135347, the entire contents of which are incorporated herein by reference.

### BACKGROUND

The present disclosure relates to a secondary battery and a method of manufacturing the secondary battery.

### BACKGROUND

The structures of secondary batteries include a laminated battery. In a laminated battery, a laminate (battery element) including a positive electrode and a negative electrode alternately stacked with a separator interposed therebetween is to be fixed in order to handle the laminate in a subsequent step without a deviation of an electrode.

For example, an attempt has been made at thermocompression-bonding a battery element including a positive electrode and a negative electrode stacked with a separator interposed therebetween in the thickness direction.

### SUMMARY

The present disclosure relates to a secondary battery and a method of manufacturing the secondary battery.

Conventional techniques, for example, have the following problems.

(1) At the time of degassing, a gas may remain inside a laminate (battery element) according to the position of thermocompression bonding, thus causing deterioration of a battery characteristic. Specifically, as shown in FIG. 25, in a case where a battery element including a positive electrode 102 and a negative electrode (not illustrated) stacked with a separator 101 interposed therebetween is subjected to thermocompression bonding at the four sides in plan view to form recesses 110, a gas 160 is not sufficiently removed. Therefore, the battery characteristic deteriorates. In the case of partial thermocompression bonding, which is not the thermocompression bonding at the four sides, the gas 160 is also not sufficiently removed, and the battery characteristic may deteriorate. FIG. 25 is a schematic plan view of a battery element in a conventional technique, for explanation of a gas remaining mechanism.

(2) Contraction of a separator may be not suppressed according to the position and the shape of thermocompression bonding, and in the worst case, an electrode is exposed from a separator, and the secondary battery may be short-circuited and ignited. Specifically, as shown in FIG. 26, at the time of manufacturing a secondary battery, a separator is unwound from a separator wound body 150 in the unwinding direction (RD direction), and then cut and used. Therefore, in plan view, for example, in a case where thermocompression bonding is performed at substantially four corners of a positive electrode 102 to form a recess 110, a separator 101 is disposed in the secondary battery in a state of being stretched in the unwinding direction (RD direction). Therefore, in the separator 101 in the secondary battery, contraction SY is caused in the MD direction with time to form a contraction portion 151, and in the worst case, the positive electrode 102 and a negative electrode (not illustrated) are exposed from the separator 101, and the secondary battery may be short-circuited and ignited. FIG. 26 is a schematic view illustrating a process of manufacturing a battery element in a conventional technique, for explanation of a separator contraction mechanism.

(3) Meanwhile, in a case where thermocompression bonding is performed at only an end (for example, the four sides) or at the entire surface in plan view in order to suppress contraction of the separator sufficiently, not only the contraction SY but also a warp SO is caused in a laminate (battery element) 170 by a residual stress of the separator as illustrated in FIG. 27. If a warp is caused, the battery element cannot be smoothly housed in an exterior body, resulting in deterioration of the manufacturing efficiency. FIG. 27 is a schematic sectional view of a battery element in a conventional technique, for explanation of a warp of a battery element.

The present disclosure, in an embodiment, relates to providing a secondary battery that achieves not only further sufficient removal of a residual gas but also further sufficient suppression of contraction of a separator and a warp of a battery element.

The present disclosure, in an embodiment, relates to a secondary battery including:
a battery element including a positive electrode and a negative electrode that are stacked with a separator interposed between the positive electrode and the negative electrode; and
an exterior body housing the battery element,
the separator having two or more first recesses and one or more second recesses disposed between two first recesses adjacent to each other among the two or more first recesses in one periphery facing region facing a periphery of the positive electrode.

The secondary battery of the present disclosure, in an embodiment, achieves not only further sufficient removal of a residual gas but also further sufficient suppression of contraction of a separator and a warp of a battery element.

### BRIEF DESCRIPTION OF THE FIGURES

FIG. 1 is a schematic sectional view showing sectional view of a battery element according to an embodiment of the present disclosure for explanation of a “zigzag structure” of the battery element.

FIG. 2 is a schematic sectional view showing sectional view of a battery element according to an embodiment of the present disclosure for explanation of a “wafer structure” of the battery element.

FIG. 3 is a schematic sectional view showing sectional view of a battery element according to an embodiment of the present disclosure for explanation of a “stacking and holding structure” of the battery element.

FIG. 4 is a schematic sectional view showing sectional view of a battery element according to an embodiment of the present disclosure for explanation of a mechanism for forming a recess in the battery element.

FIG. 5 is a schematic sectional view showing sectional view of a battery element according to an embodiment of the present disclosure for explanation of a mechanism for forming a recess in the battery element.

FIG. 6 is a schematic sectional view showing sectional view of a conventional battery element for explanation of the complexity of handling a battery element having no recess.

FIG. 7 is a schematic plan view of a battery element according to an embodiment of the present disclosure, for explanation of details of a first recess and a second recess in a separator.

FIG. 8 is a schematic plan view of a battery element according to an embodiment of the present disclosure, for explanation of details of a first recess and a second recess in a separator.

FIG. 9 is a schematic plan view of a battery element according to an embodiment of the present disclosure, for explanation of details of a first recess and a second recess in a separator.

FIG. 10 is a schematic plan view of a battery element according to an embodiment of the present disclosure, for explanation of details of a first recess and a second recess in a separator.

FIG. 11 is a schematic plan view of a battery element according to an embodiment of the present disclosure, for explanation of details of a first recess and a second recess in a separator.

FIG. 12 is a schematic plan view of a battery element according to an embodiment of the present disclosure, for explanation of details of a first recess and a second recess in a separator.

FIG. 13 is a schematic plan view of a battery element according to an embodiment of the present disclosure, for explanation of details of a first recess and a second recess in a separator.

FIG. 14 is a schematic plan view of a battery element according to an embodiment of the present disclosure, for explanation of details of a first recess and a second recess in a separator.

FIG. 15 is a schematic plan view of a battery element according to an embodiment of the present disclosure, for explanation of details of a first recess and a second recess in a separator.

FIG. 16 is a schematic plan view of a battery element according to an embodiment of the present disclosure, for explanation of details of a first recess and a second recess in a separator.

FIG. 17 is a schematic plan view of a battery element according to an embodiment of the present disclosure, for explanation of details of a first recess, a second recess, and a third recess in a separator.

FIG. 18 is a schematic plan view of a battery element according to an embodiment of the present disclosure, for explanation of details of a first recess, a second recess, and a third recess in a separator.

FIG. 19 is a schematic plan view of a battery element according to an embodiment of the present disclosure, for explanation of details of a first recess, a second recess, and a third recess in a separator.

FIG. 20 is a schematic plan view of a battery element according to an embodiment of the present disclosure, for explanation of details of a first recess, a second recess, and a third recess in a separator.

FIG. 21 is a schematic plan view of a battery element according to an embodiment of the present disclosure, for explanation of details of a first recess, a second recess, and a third recess in a separator.

FIG. 22 is a schematic plan view of a battery element according to an embodiment of the present disclosure, for explanation of details of a first recess, a second recess, and a third recess in a separator.

FIG. 23 is a schematic plan view of a battery element according to an embodiment of the present disclosure, for explanation of details of a first recess, a second recess, and a third recess in a separator.

FIG. 24 is a schematic plan view of a battery element according to an embodiment of the present disclosure, for explanation of details of a first recess, a second recess, and a third recess in a separator.

FIG. 25 is a schematic plan view of a battery element in a conventional technique, for explanation of a gas remaining mechanism.

FIG. 26 is a schematic view illustrating a process of manufacturing a battery element in a conventional technique, for explanation of a separator contraction mechanism.

FIG. 27 is a schematic sectional view of a battery element in a conventional technique, for explanation of a warp of a battery element.

### DETAILED DESCRIPTION

The secondary battery according to the present disclosure will be described below in further detail according to an embodiment. Although the description will be made with reference to the drawings as necessary, various elements in the drawings are only schematically and exemplarily illustrated for understanding of the present disclosure, and the appearances, the dimensional ratios, and the like may be different from actual ones.

The “sectional view” described directly or indirectly in the present description is based on a virtual section obtained by cutting a secondary battery along a laminating direction or a stacking direction of a battery element (that is, a separator, a positive electrode, and a negative electrode) included in the secondary battery. Similarly, the direction of a “thickness” described directly or indirectly in the present description is based on the laminating direction of a battery element (that is, a separator, a positive electrode, and a negative electrode) included in the secondary battery. For example, in the case of a “secondary battery having a thickness in a plate shape” having a button shape (or a coin shape) or the like, the direction of the “thickness” is equivalent to the plate thickness direction of the secondary battery. The term “plan view” used in the present description is based on a sketch of an object viewed from above or below along the thickness direction.

A “vertical direction” and a “horizontal direction” used directly or indirectly in the present description is equivalent to a vertical direction and a horizontal direction in the drawings, respectively. Unless otherwise specified, the same reference signs or symbols denote the same members and/or sites, or the same semantic contents. In a preferred aspect, it can be understood that a downward direction in a vertical direction (that is, a direction in which gravity acts) is equivalent to a “downward direction”, and an opposite direction is equivalent to an “upward direction”.

The secondary battery of the present disclosure includes a battery element and an exterior body that houses the battery element, and usually further includes an electrolyte. In the present description, the term “secondary battery” refers to a battery that can be repeatedly charged and discharged. Thus, a secondary battery according to an embodiment of the present disclosure is not excessively limited by its name, and for example, an electrochemical device such as a power storage device and the like may also be included in the subject of the present disclosure.

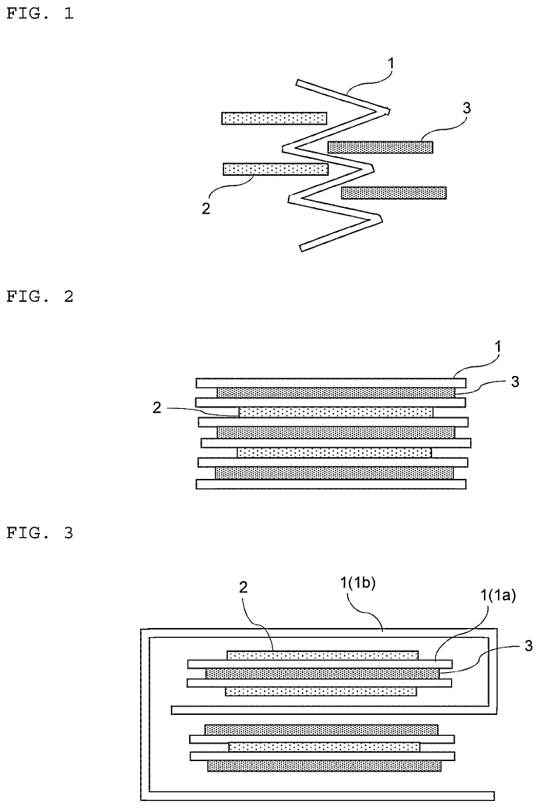

The battery element is a laminate including a positive electrode and a negative electrode stacked with a separator interposed therebetween. In the present disclosure, the battery element may include one or more separators 1, one or more positive electrodes 2, and one or more negative electrodes 3. The structure of the battery element is not particularly limited as long as the battery element includes a laminate including a positive electrode and a negative electrode stacked with a separator interposed therebetween. Examples of the structure of the battery element include the following structures:
“zigzag structure” in which a positive electrode 2 and a negative electrode 3 are stacked with a zigzag separator 1 interposed therebetween as shown in FIG. 1;
“wafer structure” in which a positive electrode 2 and a negative electrode 3 are stacked with a wafer-form separator 1 interposed therebetween as shown in FIG. 2;
“stacking and holding structure” in which a plurality of laminates each including a positive electrode 2 and a negative electrode 3 stacked with a wafer-form separator 1 (1a) interposed therebetween are further stacked and held with a long-form separator 1 (1b) as shown in FIG. 3;
“wound structure” in which a long laminate including a positive electrode (long form) and a negative electrode 3 (long form) stacked with a separator (long form) interposed therebetween is wound; and
“flat structure” in which a laminate (battery element) having the above-described wound structure is deformed into a flat shape by a pressure applied in the diametrical direction of the laminate.

Among the above-described structures, the “zigzag structure”, the “wafer structure”, the “stacking and holding structure”, and the like in which a positive electrode and a negative electrode each have a wafer form are classified into a laminated structure, and the battery element preferably has a laminated structure. Because a laminated structure achieves not only further sufficient removal of a residual gas but also further sufficient suppression of contraction of a separator and a warp of a battery element.

In the present disclosure, the separator has a first recess and a second recess that are specifically disposed. A recess such as the first recess or the second recess (or the third recess described below) is a region more depressed than its peripheral region, and a region that may also be referred to as a “depression” or “pressure bonding portion”. These recesses are regions that are provided in the partial pressure-bonding step described below and remain after the subsequent entire surface pressure-bonding step, and thus may also be referred to as “indentations”. Specifically, when a secondary battery manufactured through the partial pressure-bonding step (and the entire surface pressure-bonding step performed as necessary) is disassembled and only the separator is taken out, each recess provided in the partial pressure-bonding step remains and can be easily detected.

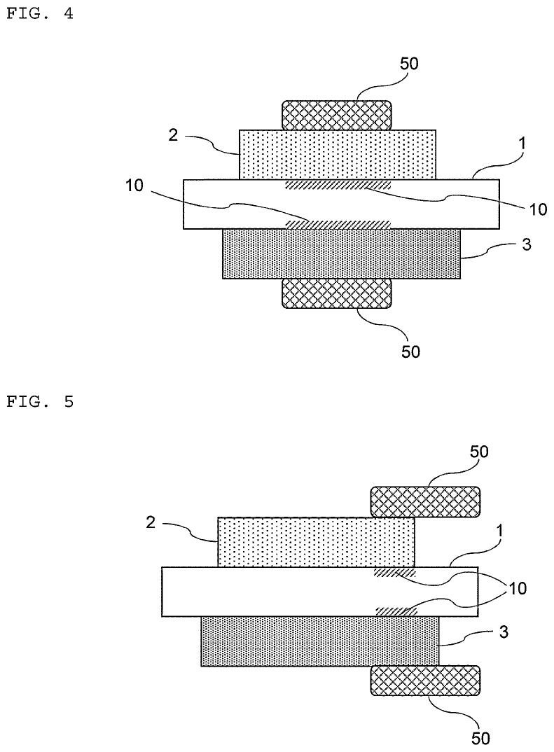

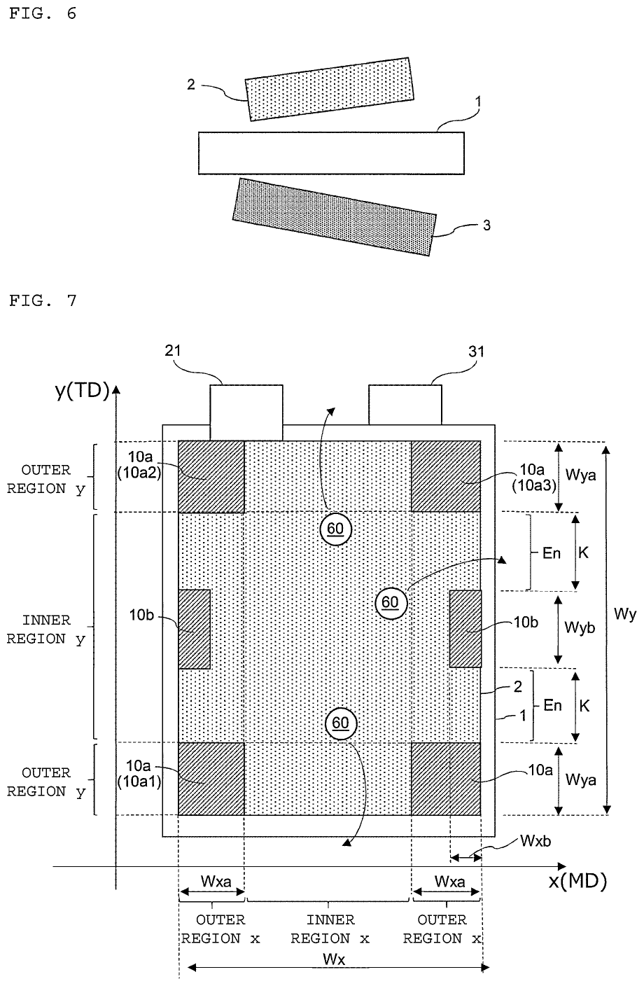

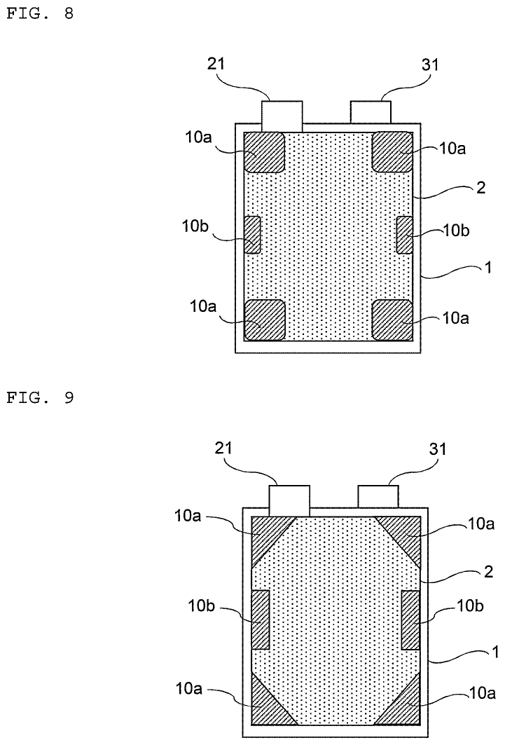

A recess 10 such as the first recess or the second recess (or the third recess described below) is a region more depressed than its peripheral region as described above, and is formed, for example, by stacking and pressurizing a separator 1, a positive electrode 2, and a negative electrode 3 with a pressurizing jig 50 as shown in FIG. 4 in the partial pressure-bonding step described below. Such a recess 10 allows the battery element to have an appropriate holding force between the separator 1 and the positive electrode 2 and between the separator 1 and the negative electrode 3, and allows the battery element to be smoothly and easily handled in a subsequent step. For example, as shown in FIG. 5, a recess 10 is formed at a site where a separator 1, a positive electrode 2, and a negative electrode 3 are present between two pressurizing jigs 50. The positive electrode and the negative electrode each have a surface on which an electrode active material and another component are present in the form of particles, and therefore it is considered that entanglement of the separator with these particles develops the holding force. In the case of a separator having an adhesive layer, the holding force is also developed by adhesion to the positive electrode and the negative electrode with the adhesive layer. As shown in FIG. 6, a battery element having no recess 10 does not have a holding force between a separator 1 and a positive electrode 2 and between the separator 1 and a negative electrode 3, or has too small a holding force, so that the separator 1, the positive electrode 2, and the negative electrode 3 act independently. As a result, handling of the battery element becomes remarkably complicated.

The depths of the first recess and the second recess (and the third recess described below) are not particularly limited.

In the present disclosure, the separator has the first recess and the second recess specifically in a periphery facing region.

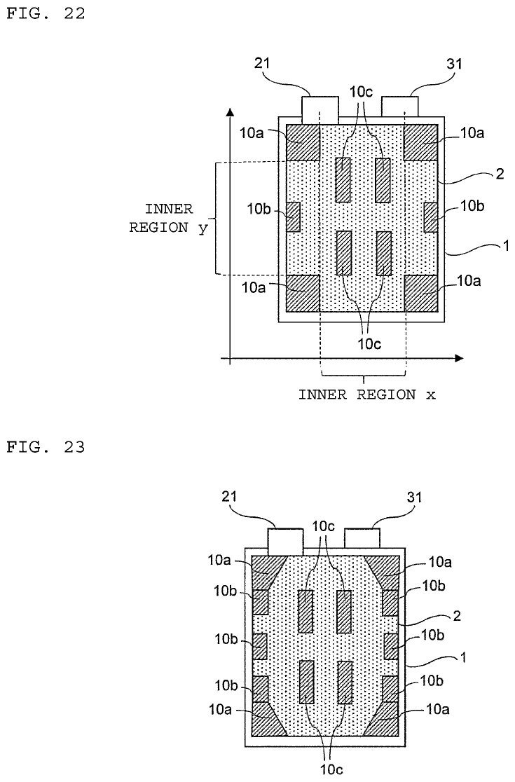

The periphery facing region is a region, in the separator, facing the periphery of the positive electrode. For example, as shown in FIGS. 7 to 24, the periphery facing region is a region, in the separator, overlapping (particularly, contacting) with the periphery of the positive electrode in plan view of the positive electrode 2 through the separator 1 in the secondary battery. The separator 1 has the periphery facing region on the surface on the positive electrode 2 side. The periphery of the positive electrode is an outer peripheral region including the outer edge (or outline) of the positive electrode in plan view of the positive electrode, and the periphery of the positive electrode is usually annular and continuous. Therefore, the periphery facing region of the separator is also annular and continuous. FIGS. 7 to 24 are each a schematic plan view of a battery element according to an embodiment, for explanation of the disposition and the dimensions of recesses in a separator.

For example, in a case where the positive electrode has a rectangular shape in plan view, one periphery facing region of the separator includes one set of outer regions x disposed to face each other in the x direction and one set of outer regions y disposed to face each other in the y direction as shown in FIGS. 7 to 23. In such one periphery facing region, an outer region x (particularly, its end) and an outer region y (particularly, its end) overlap each other to form one continuous annular shape. A region in which an end of an outer region x and an end of an outer region y overlap each other corresponds to a corner of the positive electrode in a case where the positive electrode has a rectangular shape in plan view. The corner of the positive electrode is one of four corners in plan view of the positive electrode. The x direction may be any one direction, and is usually the MD direction. The MD direction refers to the “machine direction”, and coincides with the “unwinding direction of a separator” from a separator wound body and the “contraction direction of a separator” at the time of manufacturing a secondary battery. Therefore, the MD direction can be easily detected by disassembling the secondary battery. Specifically, at the time of manufacturing a secondary battery, a separator is usually unwound from a separator wound body and then cut and used, and thus the separator is disposed in a state of being stretched in the unwinding direction in the secondary battery. Therefore, for example, when the secondary battery is disassembled and only the separator is taken out, the contraction of the separator is larger in the unwinding direction. Thus, the direction in which the contraction is larger is the “contraction direction”, and the “contraction direction” coincides with the “unwinding direction” from a separator wound body and the MD direction at the time of manufacturing a secondary battery. The y direction may be a direction intersecting the x direction on the same plane, and is usually the TD direction. The TD direction refers to the “transverse direction”, and may be, for example, the direction perpendicular to the x direction.

The disposition of each first recess is not particularly limited. For example, in a case where the positive electrode has a rectangular shape in plan view, as shown in FIGS. 7 to 23, one first recess 10a may be included in each of regions corresponding to corners (particularly, four corners) of the positive electrode in one periphery facing region. In a case where the positive electrode has a rectangular shape in plan view, a corner of the positive electrode corresponds a region in which an outer region x (particularly, its end) and an outer region y (particularly, its end) overlap each other.

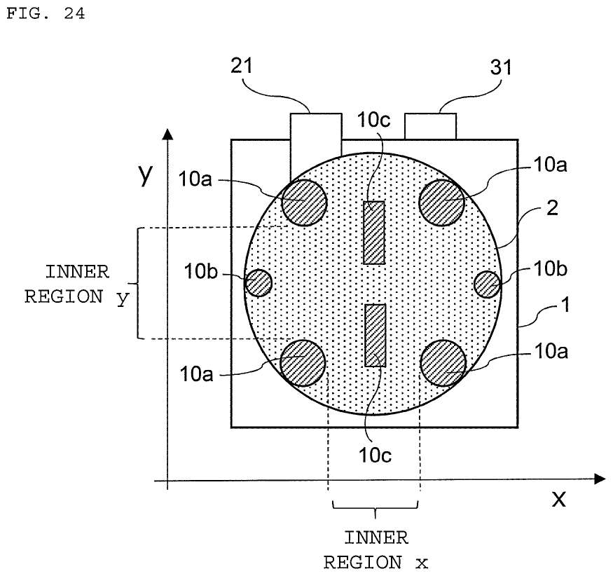

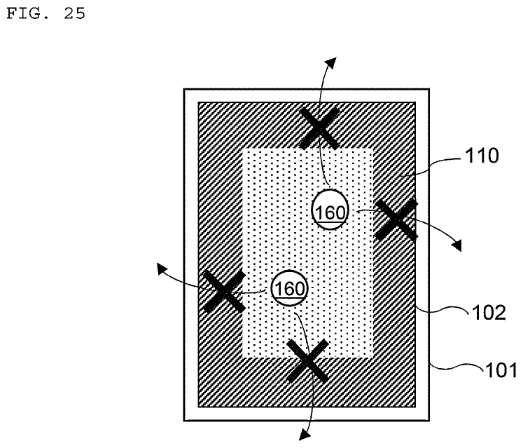

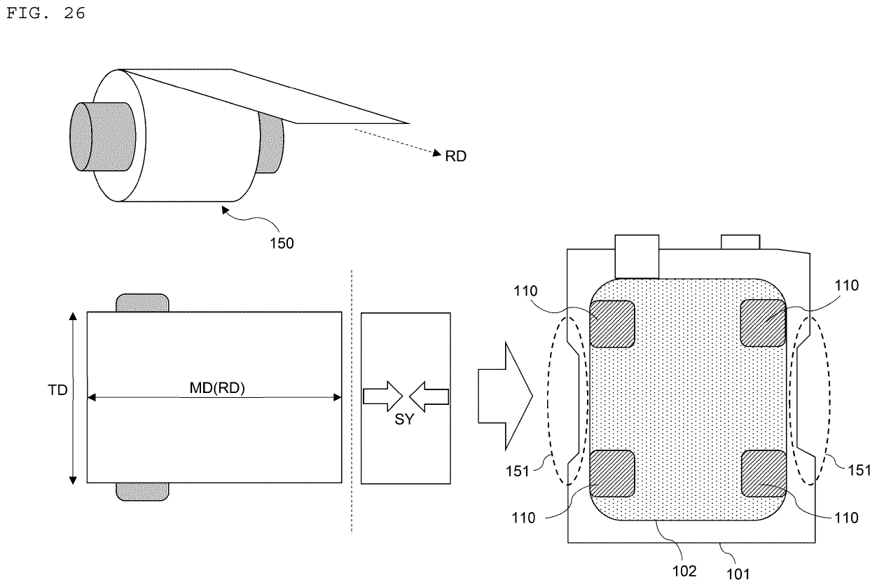

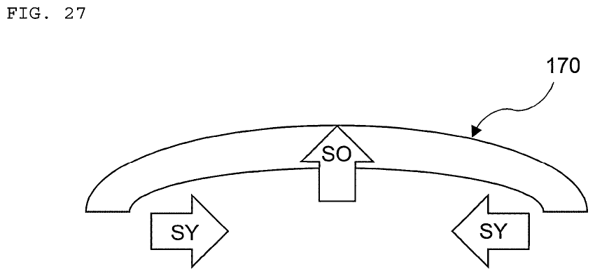

The separator has two or more first recesses 10a in one periphery facing region, and for example, in a case where the positive electrode has a rectangular shape in plan view, the separator usually has four first recesses 10a in one periphery facing region as shown in FIGS. 7 to 23. For example, in a case where the positive electrode has a circular shape in plan view, the number of first recesses 10a may be usually two or three, or four as shown in FIG. 24, or five or more. For example, in a case where the positive electrode has a circular shape in plan view, the plurality of first recesses 10a are usually disposed at equal intervals along the circumferential direction in the continuous annular shape of the periphery facing region as shown in FIG. 24.

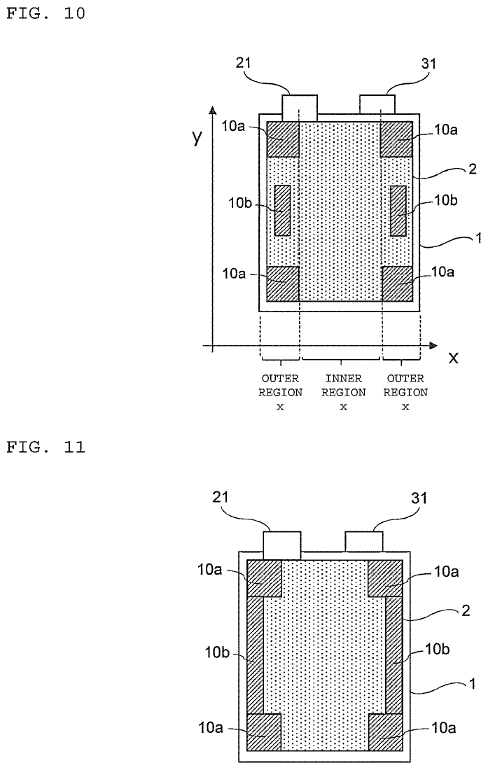

Each first recess 10a has a rectangular shape in plan view in FIGS. 7, 10 to 15, and 17 to 22, but is not limited to this shape, and may have, for example, a triangular shape (FIG. 9), a trapezoidal shape (FIGS. 16 and 23), a circular shape (FIG. 24), or a composite shape thereof. Among these shapes, the rectangular shape, the triangular shape, and the trapezoidal shape have corners formed by straight lines in plan view, but may have a corner formed by a curved line (a corner having a round shape) as shown in FIG. 8. From the viewpoint of further sufficient holding force, each first recess 10a preferably has a rectangular shape or a trapezoidal shape.

From the viewpoint of further removing a residual gas and further suppressing contraction of the separator and a warp of the battery element, each first recess 10a is preferably disposed so that at least two sides forming the outline of the first recess 10a (hereinafter, referred to as “sides m”; not illustrated) are along at least two sides forming the outline of the positive electrode (hereinafter, referred to as “sides n”; not illustrated). The phrase that “at least two sides m forming the outline of the first recess 10a are along at least two sides n forming the outline of the positive electrode” means that the two sides m overlap the two sides n in plan view as shown in FIGS. 7 to 23.

As for the widths of the first recesses 10a in the x direction (for example, MD direction), the widths Wxa of the first recesses 10a are not particularly limited, and are usually each independently 0.1×Wx or more and 0.4×Wx or less with respect to the total length Wx of the positive electrode in the x direction, and preferably 0.15×Wx or more and 0.35×Wx or less, and more preferably 0.15×Wx or more and 0.25×Wx or less from the viewpoint of further removing a residual gas and further suppressing contraction of the separator and a warp of the battery element.

As for the widths of the first recesses 10a in the perpendicular direction (y direction; for example, TD direction) to the x direction (for example, MD direction), the widths Wya of the first recesses 10a are each independently 0.1×Wy or more and 0.4×Wy or less with respect to the total length Wy of the positive electrode in the perpendicular direction, and preferably 0.15×Wy or more and 0.35×Wy or less, and more preferably 0.15×Wy or more and 0.25×Wy or less from the viewpoint of further removing a residual gas and further suppressing contraction of the separator and a warp of the battery element.

Each second recess 10b is disposed between two first recesses 10a adjacent to each other among two or more first recesses 10a of the separator. The “two first recesses 10a adjacent to each other” are two first recesses 10a adjacent to each other along the circumferential direction in the continuous annular shape of the periphery facing region. For example, in FIG. 7, a first recess 10al and a first recess 10a2 are disposed at both ends in one (in the drawing, left side) outer region x among the one set of outer regions x, and are adjacent to each other along the circumferential direction in the continuous annular shape of the periphery facing region. For example, in FIG. 7, a first recess 10a2 and a first recess 10a3 are disposed at both ends in one (in the drawing, upper side) outer region y among the one set of outer regions y, and are adjacent to each other along the circumferential direction in the continuous annular shape of the periphery facing region.

Specifically, in a case where the positive electrode has a rectangular shape in plan view, one or more second recesses 10b are disposed between two first recesses 10a at both ends in each of at least one set of outer regions among the one set of outer regions x and the one set of outer regions y. In this case, from the viewpoint of further removing a residual gas and further suppressing contraction of the separator and a warp of the battery element, one or more second recesses 10b are preferably disposed between two first recesses 10a at both ends in each of at least the one set of outer regions x as shown in FIGS. 7 to 23. Thus, contraction of the separator can be further sufficiently suppressed. For example, as shown in FIGS. 7 to 24, one or more (preferably, three or more) second recesses 10b may be disposed between two first recesses 10a at both ends in each of only the one set of outer regions x (former disposition), or one or more second recesses 10b may be disposed between two first recesses 10a at both ends in each outer region among both the one set of outer regions x and the one set of outer regions y (latter disposition). The second recesses 10b are preferably disposed in the former deposition from the viewpoint of further removing a residual gas and further suppressing contraction of the separator and a warp of the battery element.

As shown in FIGS. 7 to 23, in a case where one or more second recesses 10b are disposed between two first recesses 10a at both ends in each of at least the one set of outer regions x, each outer region x may or may not have a non-pressure-bonding region En having neither the first recess 10a nor the second recess 10b in the y direction. In this case, each outer region x preferably has a non-pressure-bonding region En in the y direction. Because the following effects 1 to 3 can be obtained according to an embodiment.

Effect 1: The non-pressure-bonding region En serves as a degassing path for a residual gas, and the residual gas can be further sufficiently removed (degassing step).

Effect 2: The machining thrust of the equipment (particularly, the pressurization equipment in the partial pressure-bonding step described below) can be reduced.

Effect 3: The separator can be further quickly impregnated with the electrolyte (liquid injection step).

In the perpendicular direction (y direction; for example, TD direction) to the x direction (for example, MD direction), the width K of the non-pressure-bonding region En is 0.1×Wy or more and 0.4×Wy or less with respect to the total length Wy of the positive electrode in the perpendicular direction, and preferably 0.15×Wy or more and 0.35×Wy or less, and more preferably 0.15×Wy or more and 0.25×Wy or less from the viewpoint of the balance between further removal of a residual gas and further suppression of contraction of the separator and a warp of the battery element.

In a case where, for example, two or more non-pressure-bonding regions En are present in one outer region (particularly, outer region x) as shown in FIG. 7, the width K of each non-pressure-bonding region is to be set so that the total width of all of the non-pressure-bonding regions En in the y direction (for example, TD direction,) in the one outer region (for example, outer region x) satisfies the above range.

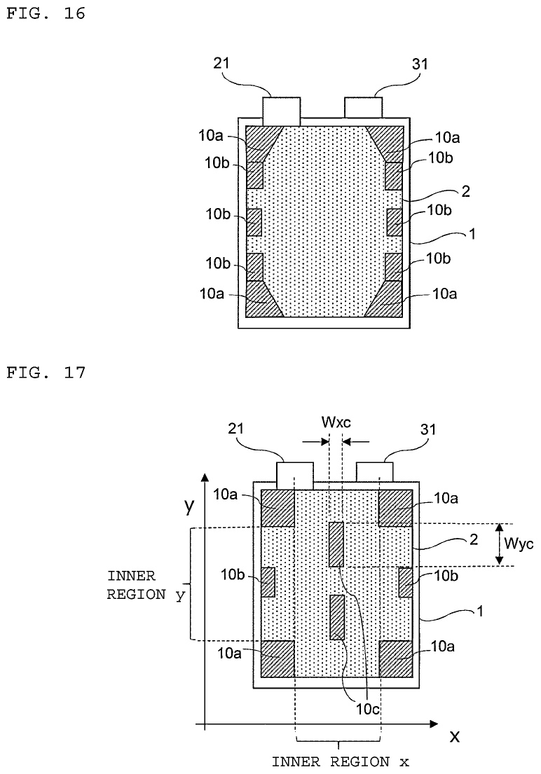

In one outer region among one set of outer regions, the number of second recesses 10b disposed between one first recess 10a and one first recess 10a is not particularly limited. Specifically, the number of second recesses 10b disposed between one first recess 10a and one first recess 10a may be, for example, one or more (particularly, one to five), and may be, for example, one as shown in FIGS. 7 to 11, 17 to 20, 22, and 24, two as shown in FIGS. 12 and 14, or three as shown in FIGS. 13, 15, 16, 21, and 23. In the present disclosure, in one set of outer regions, the number of the second recesses 10b in one outer region is not prevented from being different from the number of the second recesses 10b in the other outer region, but is preferably equal to the number of the second recesses 10b in the other outer region from the viewpoint of further removing a residual gas and further suppressing contraction of the separator and a warp of the battery element.

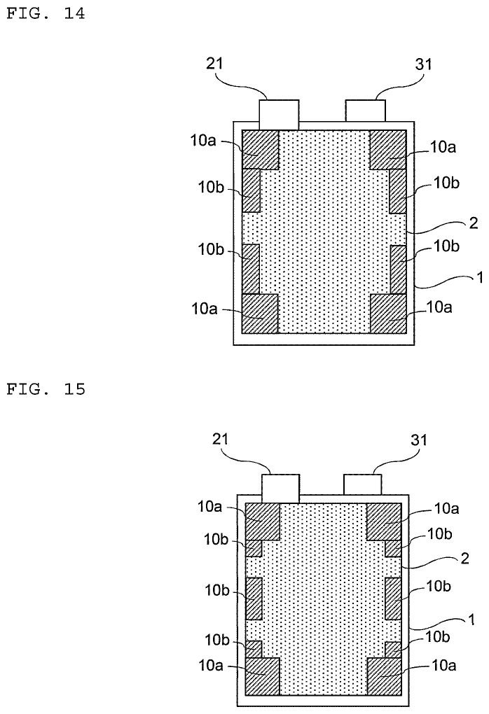

For example, in a case where the number of second recesses 10b disposed between one first recess 10a and one first recess 10a in one outer region is one, the one second recess 10b may be disposed in any one of the following embodiments p1 to p3. In this case, as shown in FIGS. 7 to 11, 17 to 20, 22, and 24, the one second recess 10b is usually disposed parallel to one direction of the x direction or the y direction (particularly, the y direction).
Embodiment p1: As shown in FIGS. 7 to 10, 17, 22, and 24, the one second recess 10b may be disposed away from two first recesses 10a at both ends.
Embodiment p2: As shown in FIGS. 11 and 18 to 20, the one second recess 10b may be disposed in direct contact with two first recesses 10a at both ends.
Embodiment p3: The one second recess 10b may be disposed away from one first recess 10a and in direct contact with the other first recess 10a.

The one second recess 10b is preferably disposed in the embodiment p1 from the viewpoint of further removing a residual gas and further suppressing contraction of the separator and a warp of the battery element.

For example, in a case where the number of second recesses 10b disposed between one first recess 10a and one first recess 10a in one outer region is two, the two second recesses 10b may be disposed in any one of the following embodiments q1 to q3. In this case, as shown in FIGS. 12 and 14, the two second recesses 10b are usually disposed parallel to one direction of the x direction or the y direction (particularly, the y direction) in one row.
Embodiment q1: As shown in FIG. 12, the two second recesses 10b may be disposed away from each other and away from two first recesses 10a at both ends.
Embodiment q2: As shown in FIG. 14, the two second recesses 10b may be disposed away from each other so that one second recess 10b is in direct contact with one of two first recesses 10a at both ends and the other second recess 10b is in direct contact with the other first recess 10a.
Embodiment q3: The two second recesses 10b may be disposed away from each other so that one second recess 10b is in direct contact with one of two first recesses 10a at both ends and the other second recess 10b is away from the other first recess 10a.

The two second recesses 10b are preferably disposed in the embodiment q1 from the viewpoint of further removing a residual gas and further suppressing contraction of the separator and a warp of the battery element.

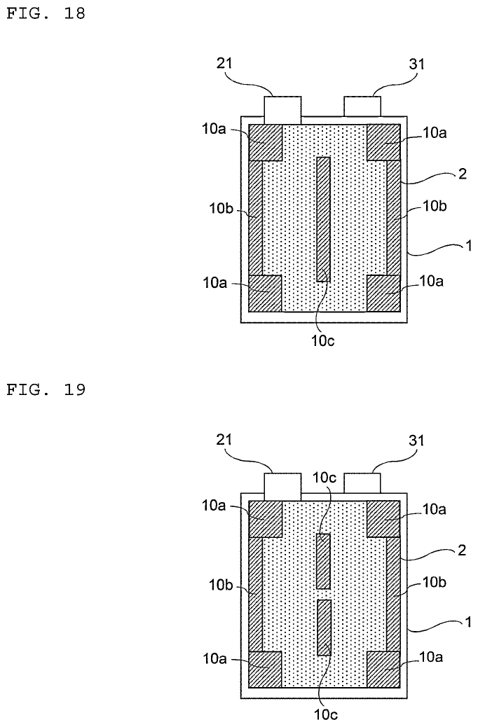

For example, in a case where the number of second recesses 10b disposed between one first recess 10a and one first recess 10a in one outer region is three or more, the second recesses 10b may be disposed in any one of the following embodiments r1 to r3. In this case, as shown in FIGS. 13, 15, 16, 21, and 23, the three or more second recesses 10b are usually disposed parallel to one direction of the x direction or the y direction (particularly, the y direction) in one row.
Embodiment r1: As shown in FIG. 13, the three or more second recesses 10b may be disposed away from each other and away from two first recesses 10a at both ends.
Embodiment r2: As shown in FIGS. 15, 16, 21, and 23, the three or more second recesses 10b may be disposed away from each other so that one of second recesses 10b at both ends in the TD direction is in direct contact with one of two first recesses 10a at both ends and the other second recess 10b is in direct contact with the other first recess 10a.
Embodiment r3: The three or more second recesses 10b may be disposed away from each other so that one of second recesses 10b at both ends in the TD direction is in direct contact with one of two first recesses 10a at both ends and the other second recess 10b is away from the other first recess 10a.

The three more second recesses 10b are preferably disposed in the embodiment r1 or r2, and more preferably disposed in the embodiment r2 from the viewpoint of further removing a residual gas and further suppressing contraction of the separator and a warp of the battery element.

Each second recess 10b has a rectangular shape in FIGS. 7 to 23, but is not limited to this shape, and may have, for example, a triangular shape, a trapezoidal shape, a circular shape (FIG. 24), or a composite shape thereof. Among these shapes, the rectangular shape, the triangular shape, and the trapezoidal shape usually have corners formed by straight lines in plan view, but may have a corner formed by a curved line (a corner having a round shape). The second recess 10b preferably has a rectangular shape from the viewpoint of further removing a residual gas and further suppressing contraction of the separator and a warp of the battery element.

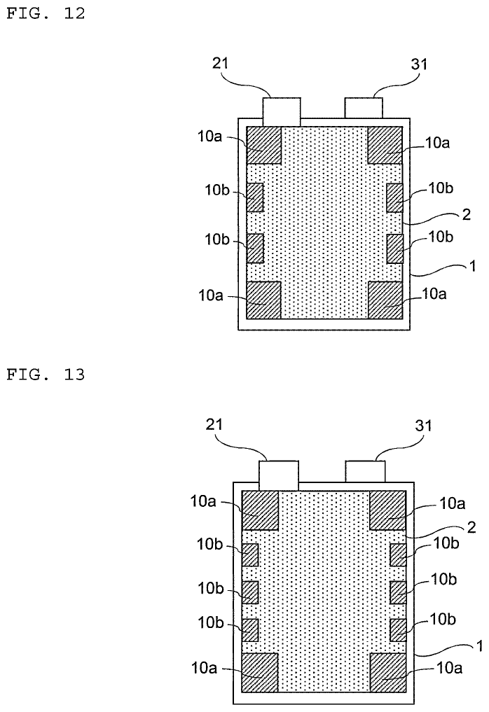

In plan view, each second recess 10b is disposed in contact with a side forming the outline of the positive electrode in FIGS. 7 to 9 and 11 to 24, but the present disclosure is not limited to this disposition, and for example, as shown in FIG. 10, each second recess 10b may be disposed away from the sides forming the outline of the positive electrode. In a case where the second recess 10b is disposed away from the sides forming the outline of the positive electrode, the second recess 10b is preferably disposed within the range of an outer region (for example, in FIG. 7, an outer region x having the width Wxa of the first recess 10a) as shown in FIG. 10 from the viewpoint of further removing a residual gas and further suppressing contraction of the separator and a warp of the battery element. At this time, the center of gravity of the second recess 10b is to be positioned in the outer region in plan view. From the viewpoint of further removing a residual gas and further suppressing contraction of the separator and a warp of the battery element, the entire second recess 10b is preferably disposed within the range of an outer region (for example, in FIG. 7, an outer region x having the width Wxa of the first recess 10a) as shown in FIG. 10. The center of gravity of the second recess 10b in plan view is a point at which a homogeneous material (for example, paper) cut along the outline of the second recess 10b (in plan view) is supported in balance.

As for the widths of the first recess 10a and the second recess 10b in the x direction (for example, MD direction), the second recess 10b has a width Wxb smaller than the width Wxa of the first recess 10a. The width Wxb of the second recess 10b is preferably 0.1×Wxa or more and 0.9×Wxa or less, more preferably 0.2×Wxa or more and 0.8×Wxa or less, and still more preferably 0.4×Wxa or more and 0.6×Wxa or less with respect to the width Wxa of the first recess 10a from the viewpoint of further removing a residual gas and further suppressing contraction of the separator and a warp of the battery element.

The widths Wxb of the second recesses are each independently 0.2×Wx or less (particularly, 0.01×Wx or more and 0.2×Wx or less) with respect to the total length Wx of the positive electrode in the x direction (for example, MD direction), and preferably 0.01×Wx or more and 0.1×Wx or less, more preferably 0.01×Wx or more and 0.05×Wx or less, and still more preferably 0.01×Wx or more and 0.03×Wx or less from the viewpoint of further removing a residual gas and further suppressing contraction of the separator and a warp of the battery element.

In a case where two or more second recesses are disposed between two first recesses at both ends in one outer region (particularly, outer region x), the width Wxb of each second recesses is to be within the above range.

As for the width of the second recess in the perpendicular direction (y direction; for example, TD direction) to the x direction (for example, MD direction), the width Wyb of the second recess is 1.0×Wy or less (particularly, 0.01×Wy or more and 1.0×Wy or less) with respect to the total length Wy of the positive electrode in the perpendicular direction, and preferably 0.1×Wy or more and 0.6×Wy or less, more preferably 0.2×Wy or more and 0.5×Wy or less, and still more preferably 0.2×Wy or more and 0.4×Wy or less from the viewpoint of further removing a residual gas and further suppressing contraction of the separator and a warp of the battery element.

In a case where two or more second recesses are disposed between two first recesses at both ends in one outer region (particularly, outer region x), the total width of the widths Wyb of all of the two or more second recesses 10b is to satisfy the above range in the y direction (for example, TD direction,) in the one outer region (for example, outer region x).

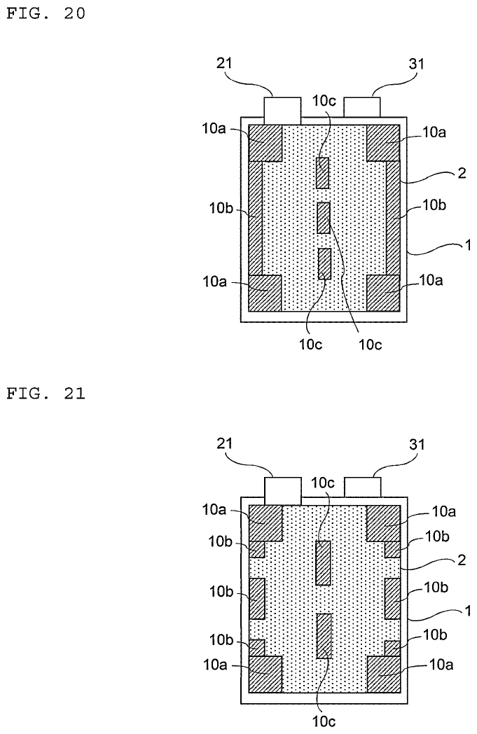

The separator preferably has a third recess in an inner region inside the periphery facing region. As shown in FIG. 7, the inner region inside the periphery facing region is an overlapping region of an inner region x inside one set of outer regions x disposed to face each other in the x direction with an inner region y inside one set of outer regions y disposed to face each other in the y direction. If a third recess 10c is disposed in such an inner region as shown in FIGS. 17 to 24, a residual gas can be further sufficiently removed, and contraction of the separator and a warp of the battery element can be further sufficiently suppressed. In particular, if the third recess 10c is locally disposed as described above, a warp of the battery element can be more sufficiently suppressed.

The number of third recesses 10c of the separator in one inner region inside one periphery facing region is not particularly limited. The number of the third recesses 10c is usually 1 or more (particularly, 1 to 10), and may be, for example, 1 (FIG. 18), 2 (FIGS. 17, 19, 21, and 24), 3 (FIG. 20), or 4 (FIGS. 22 and 23).

The disposition of each third recess 10c is not particularly limited as long as the third recess 10c is disposed in the inner region. Each third recess 10c has, for example, its center of gravity positioned in the inner region in plan view. The center of gravity of the third recess 10c in plan view is a point at which a homogeneous material (for example, paper) cut along the outline of the third recess 10c (in plan view) is supported in balance.

In one inner region inside one periphery facing region, third recesses may be usually disposed in one or more rows (for example, one or more and five or less rows, preferably one or more and three or less rows, and more preferably two rows) and one or more columns (for example, one or more and four or less columns, preferably one or more and three or less columns, and more preferably two columns). For indicating the disposition of third recesses 10c in the separator in the x direction (for example, MD direction) and the y direction (for example, TD direction), the term “row” refers to a series of third recesses 10c disposed parallel to the y direction or the number thereof. For indicating the disposition of third recesses 10c in the separator in the x direction (for example, MD direction) and the y direction (for example, TD direction), the term “column” refers to a series of third recesses 10c disposed parallel to the x direction or the number thereof.

For example, in a case where the number of third recesses 10c is one in one inner region, the one third recess 10c may be disposed in the following embodiment s1.
Embodiment s1: As shown in FIG. 18, the one third recess 10c may be disposed parallel to the y direction.

The one third recess 10c is preferably disposed so as to overlap the center of gravity of the positive electrode in plan view from the viewpoint of further removing a residual gas and further suppressing contraction of the separator and a warp of the battery element. The center of gravity of the positive electrode in plan view is a point at which a homogeneous material (for example, paper) cut along the outline of the positive electrode (in plan view) is supported in balance.

For example, in a case where the number of third recesses 10c is two in one inner region, the two third recesses 10c may be disposed in any one of the following embodiments t1 to t2.
Embodiment t1: As shown in FIGS. 17, 19, 21, and 24, the two third recesses 10c may be disposed away from each other in one row and two columns, and the two third recesses 10c in the one row are preferably disposed parallel to the y direction.
Embodiment t2: The two third recesses 10c may be disposed away from each other in two rows and one column, and the two third recesses 10c in the one column are preferably disposed parallel to the x direction.

In the embodiments t1 and t2, the two third recesses 10c are preferably disposed so that the center of gravity of the positive electrode is positioned between the two third recesses 10c in plan view from the viewpoint of further removing a residual gas and further suppressing contraction of the separator and a warp of the battery element.

The two third recesses 10c are preferably disposed in the embodiment t1 from the viewpoint of further removing a residual gas and further suppressing contraction of the separator and a warp of the battery element.

For example, in a case where the number of third recesses 10c is three in one inner region, the three third recesses 10c may be disposed in any one of the following embodiments u1 to u2.
Embodiment u1: As shown in FIG. 20, the three third recesses 10c may be disposed away from each other in one row and three columns, and the three third recesses 10c in the one row are preferably disposed parallel to the y direction.
Embodiment u2: The three third recesses 10c may be disposed away from each other in three rows and one column, and the three third recesses 10c in the one column are preferably disposed parallel to the y direction.

In the embodiments u1 and u2, the third recess 10c at the center of the three third recesses 10c is preferably disposed so as to overlap the center of gravity of the positive electrode in plan view from the viewpoint of further removing a residual gas and further suppressing contraction of the separator and a warp of the battery element.

The three third recesses 10c are preferably disposed in the embodiment u1 from the viewpoint of further removing a residual gas and further suppressing contraction of the separator and a warp of the battery element.

For example, in a case where the number of third recesses 10c is four in one inner region, the four third recesses 10c may be disposed in any one of the following embodiments v1 to v3.
Embodiment v1: The four third recesses 10c may be disposed away from each other in one row and four columns, the four third recesses 10c in the one row are preferably disposed parallel to the y direction, and the third recesses 10c of the second order and the third order in the row direction (y direction) among the four third recesses 10c are preferably disposed so that the center of gravity of the positive electrode is positioned between the third recesses 10c of the second order and the third order in plan view from the viewpoint of further removing a residual gas and further suppressing contraction of the separator and a warp of the battery element.
Embodiment v2: As shown in FIGS. 22 to 23, the four third recesses 10c may be disposed away from each other in two rows and two columns, the two third recesses 10c in each row are preferably disposed parallel to the y direction, the two third recesses 10c in each column are preferably disposed parallel to the x direction, and the four third recesses 10c are preferably disposed so that the center of gravity of the positive electrode is positioned among the four third recesses 10c in plan view from the viewpoint of further removing a residual gas and further suppressing contraction of the separator and a warp of the battery element.
Embodiment v3: The four third recesses 10c may be disposed away from each other in four rows and one column, the four third recesses 10c in the one column are preferably disposed parallel to the x direction, and the third recesses 10c of the second order and the third order in the column direction (x direction) among the four third recesses 10c are preferably disposed so that the center of gravity of the positive electrode is positioned between the third recesses 10c of the second order and the third order in plan view from the viewpoint of further removing a residual gas and further suppressing contraction of the separator and a warp of the battery element.

In the embodiments v1 and v3, the four third recesses 10c are preferably disposed in the embodiment v2 from the viewpoint of further removing a residual gas and further suppressing contraction of the separator and a warp of the battery element.

Each third recess 10c has a rectangular shape in FIGS. 17 to 24, but is not limited to this shape, and may have, for example, a triangular shape, a trapezoidal shape, a circular shape, or a composite shape thereof. Among these shapes, the rectangular shape, the triangular shape, and the trapezoidal shape usually have corners formed by straight lines in plan view, but may have a corner formed by a curved line (a corner having a round shape).

As for the widths of the third recesses 10c in the x direction (for example, MD direction), the widths Wxc of the third recesses 10c are each independently 0.1×Wx or more and 0.4×Wx or less with respect to the total length Wx of the positive electrode in the x direction (for example, MD direction), and preferably 0.15×Wx or more and 0.35×Wx or less, and more preferably 0.15×Wx or more and 0.25×Wx or less from the viewpoint of further removing a residual gas and further suppressing contraction of the separator and a warp of the battery element.

In a case where two or more third recesses 10c are disposed in each column, the width Wxc of each third recess is to satisfy the above range.

As for the widths of the third recesses 10c in the perpendicular direction (y direction; for example, TD direction) to the x direction (for example, MD direction), the widths Wyc of the third recesses 10c are each independently 0.1×Wy or more and 1.0×Wy or less with respect to the total length Wy of the positive electrode in the perpendicular direction, and preferably 0.2×Wy or more and 0.6×Wy or less, and more preferably 0.3×Wy or more and 0.5×Wy or less from the viewpoint of further removing a residual gas and further suppressing contraction of the separator and a warp of the battery element.

In a case where two or more third recesses 10c are disposed in each row, the width Wyc of each third recess is to be such that the total width of all of the third recesses 10c in each row in the y direction (for example, TD direction,) satisfies the above range.

An embodiment is described above in which the separator 1 has the first recess and the second recess in a predetermined disposition in one periphery facing region facing the periphery of the positive electrode and has the third recess in a predetermined disposition in the inner region as necessary. However, the present disclosure is not limited to such an embodiment, and may include the following embodiments instead of or in addition to such an embodiment.

(Embodiment 1) A positive electrode has the first recess and the second recess in a predetermined disposition in a periphery of the positive electrode, and further has the third recess in a predetermined disposition in the inner region as necessary, and the predetermined dispositions of the first recess, the second recess, and the third recess of the positive electrode in the embodiment 1 correspond to predetermined dispositions of the first recess, the second recess, and the third recess of the separator in an embodiment described above, respectively.

(Embodiment 2) A negative electrode has the first recess and the second recess in a predetermined disposition in one periphery facing region facing a periphery of a positive electrode, and further has the third recess in a predetermined disposition in the inner region as necessary, and the predetermined dispositions of the first recess, the second recess, and the third recess of the negative electrode in the embodiment 2 correspond to predetermined dispositions of the first recess, the second recess, and the third recess of the separator in an embodiment described above, respectively.

The positive electrode 2 is not particularly limited, and for example, includes at least a positive electrode layer and a positive electrode current collector. In the positive electrode, the positive electrode layer is provided on at least one side of the positive electrode current collector, and the positive electrode layer contains a positive electrode active material as an electrode active material. For example, in each of a plurality of the positive electrodes in the battery element, the positive electrode layer may be provided on both sides of the positive electrode current collector, or may be provided only on one side of the positive electrode current collector.

The negative electrode 3 is not particularly limited, and for example, includes at least a negative electrode layer and a negative electrode current collector. In the negative electrode, the negative electrode layer is provided on at least one side of the negative electrode current collector, and the negative electrode layer contains a negative electrode active material as an electrode active material. For example, in each of a plurality of the negative electrodes in the battery element, the negative electrode layer may be provided on both sides of the negative electrode current collector, or may be provided only on one side of the negative electrode current collector.

The electrode active materials contained in the positive electrode and the negative electrode, that is, the positive electrode active material and the negative electrode active material are materials directly involved in transfer of electrons in the secondary battery, and are main materials of the positive and negative electrodes that are responsible for charge and discharge, that is, a battery reaction. More specifically, ions are brought into the electrolyte due to the “positive electrode active material contained in the positive electrode layer” and the “negative electrode active material contained in the negative electrode layer”, such ions move between the positive electrode and the negative electrode to transfer electrons, and thus charge and discharge are performed. Such mediating ions are not particularly limited as long as charge and discharge can be performed, and examples of the mediating ions include lithium ions and sodium ions (particularly, lithium ions). The positive electrode layer and the negative electrode layer may be layers particularly capable of occluding and releasing lithium ions. In a case where lithium ions are involved in charge and discharge, the secondary battery according to the present disclosure is equivalent to a so-called “lithium ion secondary battery”, and the positive electrode and the negative electrode include a layer capable of occluding and releasing lithium ions.

The positive electrode active material in the positive electrode layer includes, for example, a granule, and the positive electrode layer may contain a binder for further sufficient contact between the particles and shape retention. Furthermore, the positive electrode layer may contain a conductive auxiliary in order to facilitate electron transfer for promotion of the battery reaction. Similarly, the negative electrode active material in the negative electrode layer includes, for example, a granule, and the negative electrode layer may contain a binder for further sufficient contact between the particles and shape retention, and may contain a conductive auxiliary in order to facilitate electron transfer for promotion of the battery reaction. As described above, the positive electrode layer and the negative electrode layer have a form containing a plurality of components, and therefore may also be referred to as “positive electrode mixture layer” and “negative electrode mixture layer”, respectively.

The positive electrode active material is not particularly limited, and may be a material that contributes to occlusion and release of lithium ions. From such a viewpoint, the positive electrode active material may be, for example, a lithium-containing composite oxide. More specifically, the positive electrode active material may be a lithium-transition metal composite oxide containing lithium and at least one transition metal selected from the group consisting of cobalt, nickel, manganese, and iron. That is, the positive electrode layer of the secondary battery according to the present disclosure may contain such a lithium-transition metal composite oxide as the positive electrode active material. For example, the positive electrode active material may be lithium cobalt oxide, lithium nickel oxide, lithium manganese oxide, lithium iron phosphate, or a material obtained by replacing a part of the transition metal in a positive electrode active material described above with another metal. Such positive electrode active materials may be contained singly, or in combination of two or more thereof.

The binder that can be contained in the positive electrode layer is not particularly limited, and examples of the binder include at least one selected from the group consisting of polyvinylidene fluoride, vinylidene fluoride-hexafluoropropylene copolymers, vinylidene fluoride-tetrafluoroethylene copolymers, polytetrafluoroethylene, and the like. The conductive auxiliary that can be contained in the positive electrode layer is not particularly limited, and examples of the conductive auxiliary include at least one selected from carbon blacks such as thermal black, furnace black, channel black, Ketjen black, and acetylene black, carbon fibers such as graphite, carbon nanotubes, and vapor-grown carbon fibers, metal powders such as copper, nickel, aluminum, and silver, polyphenylene derivatives, and the like.

The negative electrode active material is not particularly limited, and may be a material that contributes to occlusion and release of lithium ions. From such a viewpoint, the negative electrode active material may be, for example, various carbon materials, oxides, and/or lithium alloys.

Examples of the various carbon materials as the negative electrode active material include graphite (natural graphite and artificial graphite), hard carbon, soft carbon, and diamond-like carbon. In particular, graphite has high electron conductivity, and is excellent in adhesiveness to the negative electrode current collector. Examples of the oxides as the negative electrode active material include at least one selected from the group consisting of silicon oxide, tin oxide, indium oxide, zinc oxide, lithium oxide, and the like. The lithium alloy as the negative electrode active material may be an alloy of any metal as long as the metal can be alloyed with lithium, and the lithium alloy may be, for example a binary, ternary, or higher alloy of a metal such as Al, Si, Pb, Sn, In, Bi, Ag, Ba, Ca, Hg, Pd, Pt, Te, Zn, or La and lithium. Such an oxide may be amorphous in its structural form. Because deterioration due to nonuniformity such as a crystal grain boundary or a defect is less likely to be caused.

The binder that can be contained in the negative electrode layer is not particularly limited, and examples of the binder include at least one selected from the group consisting of styrene butadiene rubber, polyacrylic acid, polyvinylidene fluoride, polyimide-based resins, and polyamideimide-based resins. For example, the binder contained in the negative electrode layer may be styrene butadiene rubber. The conductive auxiliary that can be contained in the negative electrode layer is not particularly limited, and examples of the conductive auxiliary include at least one selected from carbon blacks such as thermal black, furnace black, channel black, Ketjen black, and acetylene black, carbon fibers such as graphite, carbon nanotubes, and vapor-grown carbon fibers, metal powders such as copper, nickel, aluminum, and silver, polyphenylene derivatives, and the like. The negative electrode layer may contain a component derived from a thickener component (for example, carboxymethyl cellulose) used at the time of manufacturing the battery.

The positive electrode current collector and the negative electrode current collector used in the positive electrode and the negative electrode are members that contribute to collection and supply of electrons generated in the active materials by the battery reaction. Such a current collector may be a sheet-like metal member and may be in a porous or perforated form. For example, the current collector may be a metal foil, a punching metal, a net, an expanded metal, or the like. The positive electrode current collector used in the positive electrode may include a metal foil containing at least one selected from the group consisting of aluminum, stainless steel, nickel, and the like, and may be, for example, an aluminum foil. Meanwhile, the negative electrode current collector used in the negative electrode may include a metal foil containing at least one selected from the group consisting of copper, stainless steel, nickel, and the like, and may be, for example, a copper foil.

The positive electrode 2 and the negative electrode 3 may each have a positive electrode tab 21 and a negative electrode tab 31. The positive electrode tab 21 and the negative electrode tab 31 are electrically connected to the positive electrode and the negative electrode, respectively, and are also electrically connected to respective external terminals. The positive electrode tab and the negative electrode tab may be extended portions of the positive electrode current collector and the negative electrode current collector, respectively, or may be joined, as another member, to the positive electrode and the negative electrode, respectively. The positive electrode tab may be a metal foil or a metal plate made of the same material as the positive electrode current collector, and may be an aluminum foil or an aluminum plate in a preferred aspect. The negative electrode tab may be a metal foil or a metal plate made of the same material as the negative electrode current collector, and may be a copper foil or a copper plate in a preferred aspect.

The separator 1 is a member provided from the viewpoint of preventing a short circuit due to contact between the positive electrode 2 and the negative electrode 3, holding the electrolyte, and the like. In other words, it can be said that the separator is a member configured to allow ions to pass while preventing electronic contact between the positive electrode 2 and the negative electrode 3. For example, the separator may be a porous or microporous insulating member, and may have a membrane form due to its small thickness. A microporous membrane made of a polyolefin may be used as the separator, although merely an example. In this respect, the microporous membrane for use as the separator may contain, for example, only polyethylene (PE) or only polypropylene (PP) as the polyolefin. Furthermore, the separator may be a laminate including a “microporous membrane made of PE” and a “microporous membrane made of PP”. The surface of the separator may be covered with an inorganic particle coating layer and/or an adhesive layer and the like. In a case where the surface of the separator has an adhesive layer, the surface of the separator has adhesiveness. If the surface of the separator has adhesiveness, the holding force acting between the separator and the positive electrode and between the separator and the negative electrode is further improved. The adhesive layer is usually a layer formed on the surface of the separator-constituting material without closing a hole of the separator. The adhesive layer may be one that exhibits adhesiveness at normal temperature (for example, 25° C.) (sometimes referred to as adhesive layer (I)), or one that exhibits adhesiveness when melted by heating and then solidified by cooling (sometimes referred to as adhesive layer (II)).

The thickness of the separator 1 is not particularly limited, and may be, for example, 1 μm or more and 100 μm or less, and particularly 5 μm or more and 20 μm or less. The thickness of the separator 1 is the thickness inside the secondary battery (particularly, the thickness between the positive electrode and the negative electrode), and an average of values measured at any 50 points is used.

In the secondary battery of the present disclosure, the battery element including the positive electrode, the negative electrode, and the separator is enclosed in the exterior body together with the electrolyte. In a case where the positive electrode and the negative electrode include a layer capable of occluding and releasing lithium ions, the electrolyte may be a “nonaqueous” electrolyte such as an organic electrolyte and an organic solvent. That is, the electrolyte may be a nonaqueous electrolyte. In the electrolyte, metal ions released from the electrodes (the positive electrode and the negative electrode) are present, and thus the electrolyte helps transfer of metal ions in the battery reaction.

The nonaqueous electrolyte is an electrolyte containing a solvent and a solute. A specific solvent of the nonaqueous electrolyte may contain at least a carbonate. The carbonate may be a cyclic carbonate and/or a chain carbonate. Although not particularly limited, examples of the cyclic carbonate include at least one selected from the group consisting of propylene carbonate (PC), ethylene carbonate (EC), butylene carbonate (BC), and vinylene carbonate (VC). Examples of the chain carbonate include at least one selected from the group consisting of dimethyl carbonate (DMC), diethyl carbonate (DEC), ethyl methyl carbonate (EMC), and dipropyl carbonate (DPC). Although merely an example, a combination of a cyclic carbonate and a chain carbonate may be used as the nonaqueous electrolyte, and for example, a mixture of ethylene carbonate and diethyl carbonate may be used. As a specific solute of the nonaqueous electrolyte, for example, a Li salt such as LiPF₆ and/or LiBF₄ may be used.

The exterior body is not particularly limited, and may be, for example, a flexible pouch (soft bag body) or a hard case (hard casing).

In a case where the exterior body is a flexible pouch, the flexible pouch is usually formed using a laminate film, and its periphery is heat-sealed to achieve sealing. As the laminate film, a film obtained by stacking a metal foil and a polymer film is commonly used, and specific examples of the laminate film include a film having a three-layer structure including an outer layer polymer film, a metal foil, and an inner layer polymer film. The outer layer polymer film prevents damage of the metal foil caused by permeation and contact of moisture and the like, and a polymer such as a polyamide or a polyester may be used. The metal foil prevents permeation of moisture and a gas, and a foil of copper, aluminum, stainless steel, or the like may be used. The inner layer polymer film protects the metal foil from the electrolyte housed inside and is used for melt-sealing at the time of heat sealing, and a polyolefin (for example, polypropylene) or an acid-modified polyolefin may be used. The thickness of the laminate film is not particularly limited, and may be, for example, 1 μm or more and 1 mm or less.

In a case where the exterior body is a hard case, the hard case is usually formed using a metal plate, and its periphery is irradiated with a laser to achieve sealing. As the metal plate, a metal material made of aluminum, nickel, iron, copper, stainless steel, or the like is commonly used. The thickness of the metal plate is not particularly limited, and may be, for example, 1 μm or more and 1 mm or less.

The secondary battery of the present disclosure can be manufactured with a manufacturing method including the following steps according to an embodiment:
a battery element production step of stacking a positive electrode 2 and a negative electrode 3 with a separator 1 interposed between the positive electrode 2 and the negative electrode 3 to produce a battery element;
a partial pressure-bonding step of pressure-bonding a part of the battery element in a thickness direction to form the each first recess 10a and the each second recess 10b;
a housing step of housing the battery element pressure-bonded in an exterior body;
a liquid injection step of injecting an electrolyte into the exterior body housing the battery element;
a degassing step of degassing an inside of the exterior body into which the electrolyte is injected; and
a sealing step of sealing the exterior body degassed.

In the battery element production step, the separator 1, the positive electrode 2, and the negative electrode 3 are prepared, and then the positive electrode 2 and the negative electrode 3 are stacked with the separator 1 interposed therebetween to produce a battery element.

In the partial pressure-bonding step, the battery element is pressure-bonded in the thickness direction. At this time, the entire surface in the direction perpendicular to the thickness direction of the battery element is not pressurized, but a part of the surface is (and/or selectively) pressurized. For example, as shown in FIGS. 4 and 5, the separator 1, the positive electrode 2, and the negative electrode 3 are stacked and pressurized between the two pressurizing jigs 50, and thus each recess 10 is formed at a site where the separator 1, the positive electrode 2, and the negative electrode 3 are present. The recesses 10 include the first recess 10a and the second recess 10b described above, and further include the third recess 10c described above as necessary. The dispositions of the first recess 10a, the second recess 10b, and the third recess 10c can be controlled by adjusting (or selecting) the pressurizing position by the pressurizing jigs 50 and/or the shape of each pressurizing jig 50. In FIGS. 4 and 5, only one battery constituent unit including one separator 1, one positive electrode 2, and one negative electrode 3 is pressurized, but the present disclosure is not limited to such pressurizing, and two or more battery constituent units may be stacked and pressurized as long as a separator 1 is disposed so as to be interposed between a positive electrode 2 and a negative electrode 3 as a whole.

The pressurizing jig 50 may be used in an unheated state to achieve “pressure bonding”, or may be used in a heated state to achieve “thermocompression bonding”. In the present description, the pressure bonding includes “pressure bonding” in an unheated state and “thermocompression bonding” in a heated state. In the present disclosure, simple “pressure bonding” in an unheated state also develops a desired holding force between the separator and the positive electrode and between the separator and the negative electrode. The positive electrode and the negative electrode each have a surface on which an electrode active material and another component are present in the form of particles, and therefore it is considered that entanglement of the separator with these particles develops the holding force. In the present disclosure, “thermocompression bonding” in a heated state is preferably performed. Because as a result, the holding force becomes larger. The “thermocompression bonding” is significantly performed in a case where the separator has the above-described adhesive layer (II). The heating temperature of the pressurizing jig 50 for thermocompression bonding may be usually a temperature at which the adhesive layer (II) is softened or melted.

In the housing step, the pressure-bonded battery element is housed in the exterior body. In the present disclosure, the battery element having a pressure-bonded part is used, and therefore the handling at the time of housing is improved.

In the liquid injection step, the electrolyte is injected into the exterior body housing the battery element.

In the degassing step, the inside of the exterior body into which the electrolyte is injected is degassed.

In the sealing step, the degassed exterior body is sealed. Specifically, the opening of the degassed exterior body is sealed. The sealing method is not particularly limited, and for example, in a case where the exterior body is a flexible pouch, may be a heat sealing method.

In the present disclosure, an initial charging step is preferably performed between the liquid injection step and the degassing step. In the initial charging step, the exterior body housing the electrolyte is subjected to initial charging. The initial charging step is a first charging step performed for the purpose of forming an SEI film on the surface of the negative electrode, and is also referred to as a chemical conversion step. The SEI film is formed by reductive decomposition of an additive contained in the electrolyte on the negative electrode surface in this step, and prevents further decomposition of the electrolyte on the negative electrode surface during use of the secondary battery.

In the initial charging step, charging is to be performed at least once. Usually, charge and discharge is performed one or more times. The charge and discharge performed once includes charge performed once and subsequent discharge performed once. In the case of performing charge and discharge two or more times, the charge and discharge is repeated the number of times. The number of times of charge and discharge performed in this step is usually 1 or more and 3 or less.

The charging method may be a constant current charging method, a constant voltage charging method, or a combination thereof. For example, constant voltage charge and constant voltage charge may be repeated during single charge. The charging conditions are not particularly limited as long as the SEI film is formed. From the viewpoint of further improving the thickness uniformity of the SEI film, constant voltage charge may be performed after performing constant current charge.

The discharging method usually may be a constant current discharging method, a constant voltage discharging method, or a combination thereof.

In the initial charging step, a pressure may be applied in the thickness direction. In this step, the pressure is to be applied to the entire surface in the direction perpendicular to the thickness direction of the battery element.

An overall pressure-bonding step is preferably performed between the degassing step and the sealing step or after the sealing step. In the overall pressure-bonding step, a pressure is applied in the thickness direction overall to the exterior body housing the battery element and the electrolyte, and the separator, the positive electrode, and the negative electrode are pressure-bonded. In the overall pressure-bonding step, specifically, the entire surface in the direction perpendicular to the thickness direction of the battery element is pressurized. More specifically, the overall pressure-bonding step is performed with a method similar to the method of the partial pressure-bonding step except that a pressurizing jig is used that pressurizes the entire surface in the direction perpendicular to the thickness direction of the battery element and that an exterior body housing the battery element and the electrolyte is used as a pressurization target. In the overall pressure-bonding step, “thermocompression bonding” in the partial pressure-bonding step is usually performed.

The present disclosure as described above encompasses the following preferable aspects according to an embodiment.

<1> A secondary battery including:
a battery element including a positive electrode and a negative electrode that are stacked with a separator interposed between the positive electrode and the negative electrode; and
an exterior body housing the battery element,
the separator having two or more first recesses and one or more second recesses disposed between two first recesses adjacent to each other among the two or more first recesses in one periphery facing region facing a periphery of the positive electrode.

<2> The secondary battery according to <1>, wherein
the positive electrode and the negative electrode each have a rectangular shape in plan view,
the one periphery facing region includes one set of outer regions x disposed to face each other in a machine direction (MD direction) and one set of outer regions y disposed to face each other in a transverse direction (TD direction),
the two or more first recesses are disposed in regions corresponding to four corners of the rectangular shape of the positive electrode, the regions equivalent to regions in which an end of the one set of outer regions x and an end of the one set of outer regions y overlap each other, and
one or more among the one or more second recesses are disposed between two first recesses at both ends of the two or more first recesses in each outer region x among at least the one set of outer regions x.

<3> The secondary battery according to <2>, wherein
three or more second recesses among the one or more second recesses are disposed between the two first recesses at both the ends in the each outer region x among the one set of outer regions x, and
in the each outer region x, the three or more second recesses are disposed to be in one row parallel to the TD direction and satisfy an embodiment r1 or r2 described below:
   the embodiment r1 in which the three or more second recesses are disposed away from each other and away from the two first recesses at both the ends; and
   the embodiment r2 in which the three or more second recesses are disposed away from each other, one of second recesses at both ends in the TD direction among the three or more second recesses is disposed to be in contact with one of the two first recesses at both the ends, and another of the second recesses is disposed to be in contact with another of the two first recess.

<4> The secondary battery according to any one of <1> to <3>, wherein each second recess among the one or more second recesses has a width Wxb smaller than a width Wxa of each first recess among the two or more first recesses in the MD direction.

<5> The secondary battery according to <4>, wherein
the width Wxa of the each first recess is 0.1×Wx or more and 0.4×Wx or less, and
the width Wxb of the each second recess is 0.01×Wx or more and 0.2×Wx or less,
wherein Wx represents a total length of the positive electrode in the MD direction.

<6> The secondary battery according to <4> or <5>, wherein
the each first recess has a width Wya of 0.1×Wy or more and 0.4×Wy or less in the TD direction, and
the each second recess has a width Wyb of 0.01×Wy or more and 1.0×Wy or less in the TD direction,
wherein Wy represents a total length of the positive electrode in the TD direction.

<7> The secondary battery according to any one of <1> to <6>, wherein the separator has a third recess in an inner region inside the one periphery facing region.

<8> The secondary battery according to <7>, wherein one or more rows and one or more columns of third recesses are disposed in one inner region inside the one periphery facing region.

<9> The secondary battery according to <7> or <8>, wherein two rows and two columns of third recesses are disposed in the one inner region inside the one periphery facing region.

<10> The secondary battery according to any one of <7> to <9>, wherein
the third recess or the third recesses each independently have a width Wxc of 0.1×Wx or more and 0.4×Wx or less in the MD direction, wherein Wx represents the total length of the positive electrode in the MD direction.

<11> The secondary battery according to any one of <7> to <10>, wherein
the third recess or the third recesses each independently have a width Wyc of 0.1×Wy or more and 1.0×Wy or less in a perpendicular direction (for example, the TD direction) to the MD direction, wherein Wy represents a total length of the positive electrode in the perpendicular direction.

<12> The secondary battery according to any one of <1> to <11>, wherein the positive electrode and the negative electrode each have a wafer form.

<13> The secondary battery according to any one of <1> to <12>, being a lithium ion secondary battery.

<14> The secondary battery according to any one of <1> to <13>, further including an electrolyte,
the electrolyte being a nonaqueous electrolyte.

<15> The secondary battery according to any one of <1> to <14>, wherein the positive electrode and the negative electrode are each an electrode capable of occluding and releasing lithium ions.

<16> A method of manufacturing a secondary battery, the secondary battery according to any one of <1> to <15>, the method including:
a battery element production step of stacking a positive electrode and a negative electrode with a separator interposed between the positive electrode and the negative electrode to produce a battery element;
a partial pressure-bonding step of pressure-bonding a part of the battery element in a thickness direction to form the each first recess and the each second recess;
a housing step of housing the battery element pressure-bonded in an exterior body;
a liquid injection step of injecting an electrolyte into the exterior body housing the battery element;
a degassing step of degassing an inside of the exterior body into which the electrolyte is injected; and
a sealing step of sealing the exterior body degassed.

<17> The method of manufacturing a secondary battery according to <16>, including an initial charging step between the liquid injection step and the degassing step,
the initial charging step of subjecting the exterior body into which the electrolyte is injected to initial charging.

<18> The method of manufacturing a secondary battery according to <17>, wherein the initial charging step includes applying a pressure in the thickness direction.

<19> The method of manufacturing a secondary battery according to any one of <16> to <18>, including an overall pressure-bonding step between the degassing step and the sealing step or after the sealing step,
the overall pressure-bonding step being an entire surface pressure-bonding step of applying a pressure in the thickness direction overall to the exterior body housing the battery element and the electrolyte injected to pressure-bond the separator, the positive electrode, and the negative electrode.

### INDUSTRIAL APPLICABILITY

The secondary battery according to the present disclosure can be used in various fields in which battery use or power storage is assumed. The secondary battery, particularly, nonaqueous electrolyte secondary battery according to the present disclosure can be used in the field of electronics mounting, although merely an example. The secondary battery according to an embodiment of the present disclosure can also be used in the fields of electricity, information, and communication in which mobile devices and the like are used (for example, the fields of electrical/electronic devices and mobile devices including small electronic machines such as mobile phones, smartphones, smartwatches, notebook computers, digital cameras, activity meters, arm computers, electronic paper, wearable devices, RFID tags, card type electronic money, and smartwatches), home and small industrial applications (for example, the fields of electric tools, golf carts, and home/nursing/industrial robots), large industrial applications (for example, the fields of forklifts, elevators, and harbor cranes), transportation system fields (for example, the fields of hybrid vehicles, electric vehicles, buses, trains, power-assisted bicycles, electric two-wheeled vehicles), power system applications (for example, the fields of various types of power generation, road conditioners, smart grids, and household power storage systems), medical applications (the field of medical devices such as earphone hearing aids), pharmaceutical applications (the fields of dosage management systems and the like), IoT fields, space and deep sea applications (for example, the fields of space probes and submersibles), and the like.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a battery element including a positive electrode and a negative electrode that are stacked with a separator interposed between the positive electrode and the negative electrode; and
an exterior body housing the battery element,
the separator having two or more first recesses and one or more second recesses disposed between two first recesses adjacent to each other among the two or more first recesses in one periphery facing region facing a periphery of the positive electrode.

2. The secondary battery according to claim 1, wherein
the positive electrode and the negative electrode each have a rectangular shape in plan view,
the one periphery facing region includes one set of outer regions x disposed to face each other in a machine direction (MD direction) and one set of outer regions y disposed to face each other in a transverse direction (TD direction),
the two or more first recesses are disposed in regions corresponding to four corners of the rectangular shape of the positive electrode, the regions equivalent to regions in which an end of the one set of outer regions x and an end of the one set of outer regions y overlap each other, and
one or more among the one or more second recesses are disposed between two first recesses at both ends of the two or more first recesses in each outer region x among at least the one set of outer regions x.

3. The secondary battery according to claim 2, wherein
three or more second recesses among the one or more second recesses are disposed between the two first recesses at both the ends in the each outer region x among the one set of outer regions x, and
in the each outer region x, the three or more second recesses are disposed to be in one row parallel to the TD direction and satisfy r1 or r2 described below:
r1 in which the three or more second recesses are disposed away from each other and away from the two first recesses at both the ends; and
r2 in which the three or more second recesses are disposed away from each other, one of second recesses at both ends in the TD direction among the three or more second recesses is disposed to be in contact with one of the two first recesses at both the ends, and another of the second recesses is disposed to be in contact with another of the two first recess.

4. The secondary battery according to claim 1, wherein each second recess among the one or more second recesses has a width Wxb smaller than a width Wxa of each first recess among the two or more first recesses in the MD direction.

5. The secondary battery according to claim 4, wherein
the width Wxa of the each first recess is 0.1×Wx or more and 0.4×Wx or less, and
the width Wxb of the each second recess is 0.01×Wx or more and 0.2×Wx or less,
wherein Wx represents a total length of the positive electrode in the MD direction.

6. The secondary battery according to claim 4, wherein
the each first recess has a width Wya of 0.1×Wy or more and 0.4×Wy or less in the TD direction, and
the each second recess has a width Wyb of 0.01×Wy or more and 1.0×Wy or less in the TD direction,
wherein Wy represents a total length of the positive electrode in the TD direction.

7. The secondary battery according to claim 1, wherein the separator has a third recess in an inner region inside the one periphery facing region.

8. The secondary battery according to claim 7, wherein one or more rows and one or more columns of third recesses are disposed in one inner region inside the one periphery facing region.

9. The secondary battery according to claim 7, wherein two rows and two columns of third recesses are disposed in the one inner region inside the one periphery facing region.

10. The secondary battery according to claim 1, wherein
the third recess or the third recesses each independently have a width Wxc of 0.1×Wx or more and 0.4×Wx or less in the MD direction, wherein Wx represents the total length of the positive electrode in the MD direction.

11. The secondary battery according to claim 1, wherein
the third recess or the third recesses each independently have a width Wyc of 0.1×Wy or more and 1.0×Wy or less in a perpendicular direction (for example, the TD direction) to the MD direction, wherein Wy represents a total length of the positive electrode in the perpendicular direction.

12. The secondary battery according to claim 1, wherein the positive electrode and the negative electrode each have a wafer form.

13. The secondary battery according to claim 1, being a lithium ion secondary battery.

14. The secondary battery according to claim 1, further comprising an electrolyte,
the electrolyte being a nonaqueous electrolyte.

15. The secondary battery according to claim 1, wherein the positive electrode and the negative electrode are each an electrode capable of occluding and releasing lithium ions.

16. A method of manufacturing a secondary battery, the method comprising:
a battery element production step of stacking a positive electrode and a negative electrode with a separator interposed between the positive electrode and the negative electrode to produce a battery element;
pressure-bonding a part of the battery element in a thickness direction to form the each first recess and the each second recess;
housing the battery element pressure-bonded in an exterior body;
injecting an electrolyte into the exterior body housing the battery element;
degassing an inside of the exterior body into which the electrolyte is injected; and
sealing the exterior body degassed.

17. The method of manufacturing a secondary battery according to claim 16, comprising an initial charging between injecting and degassing,
the initial charging including subjecting the exterior body into which the electrolyte is injected to initial charging.

18. The method of manufacturing a secondary battery according to claim 17, wherein the initial charging includes applying a pressure in the thickness direction.

19. The method of manufacturing a secondary battery according to claim 16, comprising overall pressure-bonding between degassing and sealing or after sealing,
the overall pressure-bonding being an entire surface pressure-bonding of applying a pressure in the thickness direction overall to the exterior body housing the battery element and the electrolyte injected to pressure-bond the separator, the positive electrode, and the negative electrode.
